(19) United States
(12) Patent Application Publication
(10) Pub. No.: US 2008/0093940 A1
(43) Pub. Date: Apr. 24, 2008

(54) Assembly for connecting the stator windings of an electric motor

(75) Inventor: Ido Boischio, Padova (IT)

Correspondence Address: MODIANO & ASSOCIATI, Via Meravigli, 16, Milano, 20123, omitted

(73) Assignee: INARCA S.P.A.

(21) Appl. No.: 11/907,836

(22) Filed: Oct. 18, 2007

(30) Foreign Application Priority Data
Oct. 24, 2006 (IT) PD2006A000394

(51) Int. Cl. H02K 3/50

(52) U.S. Cl. 310/71; 310/68 R

(57) ABSTRACT

An assembly for connecting the stator windings of an electric motor to the respective power supply. The connection assembly comprises a first box-like connector provided with first internal passages which are open at their ends and are designed to accommodate corresponding first electrical terminals. The first connector is provided with a coupling to the stator which is adapted to arrange the first internal passages parallel to the axis of the electric motor. At the end part of the first internal passages there is a coupling cavity for at least one second box-like connector provided with second internal passages which are open at their ends and are designed to accommodate corresponding second electrical terminals for coupling to the first electrical terminals; the second internal passages are aligned with the first internal passages.

The present invention relates to an assembly for connecting the stator windings of an electric motor to the respective power supply.

### BACKGROUND OF THE INVENTION

It is known that the connection of the stator windings of an electric motor to the respective power supply can occur manually, or, as in recent times and in the case of a large number of connections, in an automated manner.

Automated connection provides for the use of a first box-like connector made of plastic material, which is fixed to the stator and which accommodates internally, in respective passages, first electrical terminals to which cables and wires connected to the windings are crimped, and a second box-like connector, inside which there are second electrical terminals to which the wires connected to the power supply are crimped; the first connector is coupled stably to the second connector and the respective terminals are also coupled.

In most configurations, the passages of the connectors are mutually aligned and parallel to the axis of the electric motor; the respective electrical terminals also lie in the same direction.

In certain applications, during the automated connection of the second connector to the first connector, the electrical terminals thereof, due to incorrect positioning or dimensional defects of the connectors, may tend to exit from their containment passage or move, causing jamming during connection.

### SUMMARY OF THE INVENTION

The aim of the present invention is to solve the problems noted during the connection of the stator windings of an electric motor to the respective power supply.

Within this aim, an object of the present invention is to provide a connection assembly for the stator windings of an electric motor which is stable.

Another object of the present invention is to provide an assembly for connecting the stator windings of an electric motor which does not allow jamming during the steps for connection.

Another object of the present invention is to provide an assembly for connecting the stator windings of an electric motor which is structurally simple.

This aim and these and other objects which will become better apparent hereinafter are achieved by an assembly for connecting the stator windings of an electric motor to the respective power supply, characterized in that it comprises a first box-like connector provided with first internal passages which are open at their ends and are designed to accommodate corresponding first electrical terminals, said first connector being provided with means for coupling to the stator which are adapted to arrange said first passages parallel to the axis of the electric motor, at the end part of said first internal passages there being a coupling cavity for at least one second box-like connector provided with second internal passages which are open at their ends and are designed to accommodate corresponding second electrical terminals for coupling to said first electrical terminals, said second internal passages being aligned with said first internal passages, each of said first terminals being constituted by a central flat body which has a substantially quadrangular shape and from which there protrude, in a substantially coplanar manner, a flat pin for contact with a respective said second electrical terminal and, on the opposite side with respect to said flat pin, a portion for crimping to a corresponding cable connected to the stator windings, two parallel teeth protruding from the surface of said central flat body and being suitable to avoid extraction from the corresponding internal passage, said two teeth being formed along the lateral portions of said substantially quadrangular contour which are parallel to said end, lateral guiding shoulders for said flat pins protruding from the bottom of said cavity, said lateral guiding shoulders guiding two first mutually opposite side walls of said flat pins, while the second mutually opposite side walls are free in order to allow electrical contact with said second electrical terminals.

### BRIEF DESCRIPTION OF THE DRAWINGS

Further characteristics and advantages of the invention will become better apparent from the description of a preferred but not exclusive embodiment thereof, illustrated by way of non-limiting example in the accompanying drawings, wherein:

FIG. 1 is a sectional side view of a connection assembly according to the invention;

FIG. 2 is a partially sectional front view of a portion of the connection assembly of FIG. 1;

FIG. 3 is a perspective view of an electrical terminal used in the connection assembly of the preceding figures;

FIG. 4 is a perspective view of a connector of the connection assembly of the preceding figures;

FIG. 5 is a sectional side view of the connector of FIG. 4.

### DESCRIPTION OF THE PREFERRED EMBODIMENTS

It is noted that anything found to be already known during the patenting process is understood not to be claimed and to be the subject of a disclaimer.

With reference to the figures, an assembly for connecting the stator windings of an electric motor to the respective power supply according to the invention is generally designated by the reference numeral 10.

The connection assembly 10 comprises a first box-like connector 11 provided with first internal passages 12 which are open at their ends and are designed to accommodate corresponding first electrical male terminals 13.

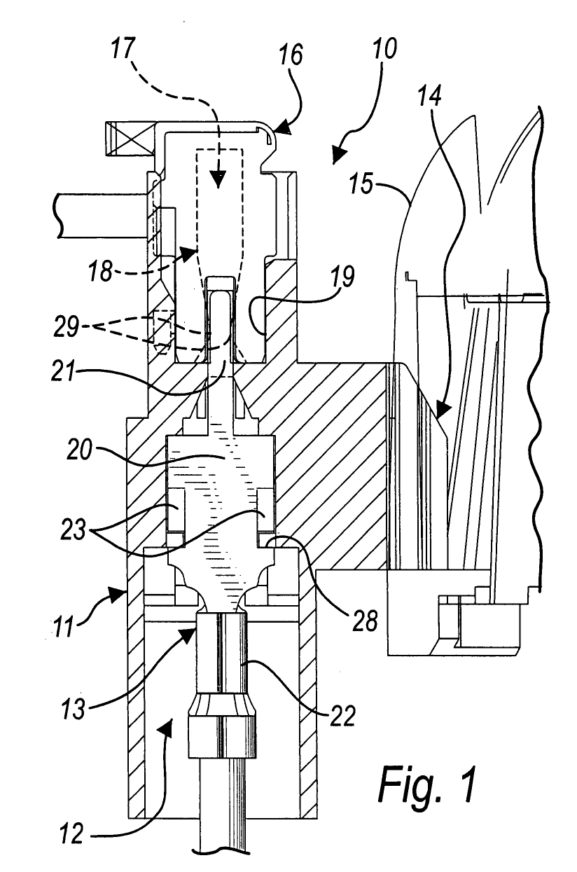

The first connector 11 is provided with means 14 for engaging with the stator, which are not described in detail since they are substantially of a known type, such as for example means for snap or interference coupling with portions of a dome made of plastic material (designated by the reference numeral 15 in FIG. 1) for covering the stator.

The engagement means 14 are configured so as to arrange the first internal passages 12 parallel to the axis of the electric motor.

The connection assembly also comprises at least one second box-like connector 16, which is provide with second internal passages 17 which are open at their ends and are designed to accommodate corresponding second female terminals 18 which mate with the first electrical terminals 13 (in FIG. 1, a second terminal 18 is shown schematically by means of broken lines).

The second connector 16 is mated with the first connector 11 by stable insertion within a cavity 19 formed at the end part of the first internal passages 12.

As shown, the second internal passages 17 are aligned with the first internal passages 12.

Each first electrical terminal 13 is constituted by a central flat body 20 which has a substantially quadrangular contour and from which there protrude, in a substantially coplanar manner, a flat pin 21 for contact with a respective second electrical terminal 18 and, on the opposite side with respect to the flat pin 21, a portion 22 for crimping to a corresponding wire connected to the stator windings; the flat pin 21 has a substantially quadrangular cross-section.

Two parallel teeth 23 protrude from the surface of the central flat body 20 and are adapted to avoid extraction from the corresponding first internal passage 12.

In particular, the two teeth 23 are provided along the lateral portions of the substantially quadrangular contour which are parallel to the end 21.

Moreover, the two teeth 23 are constituted by identical portions of the central flat body 20 which are mutually parallel; said portions are wing-shaped, are partially cut by blanking and are folded so as to rise from the flat arrangement of the central flat body 20.

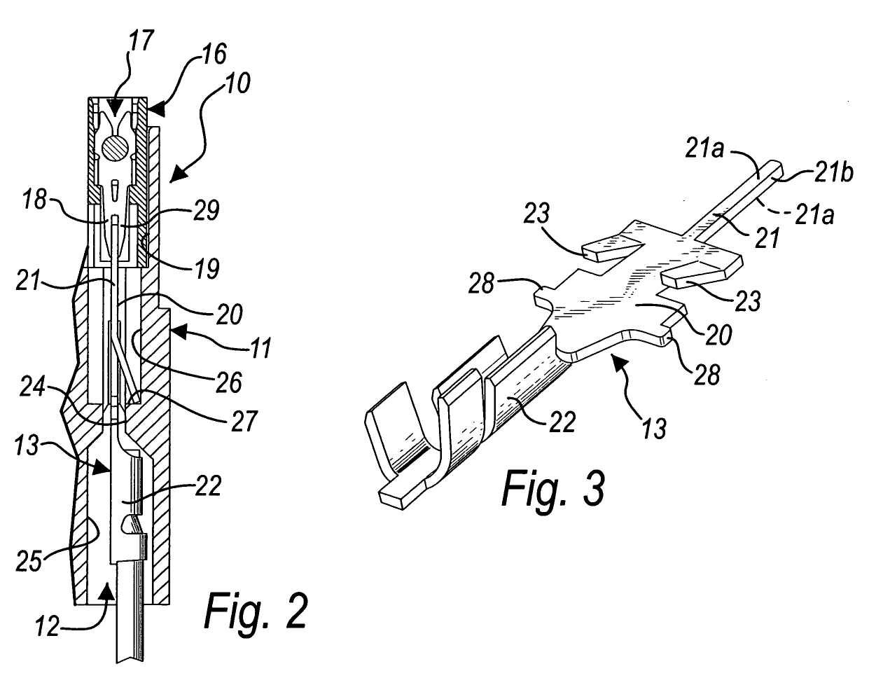

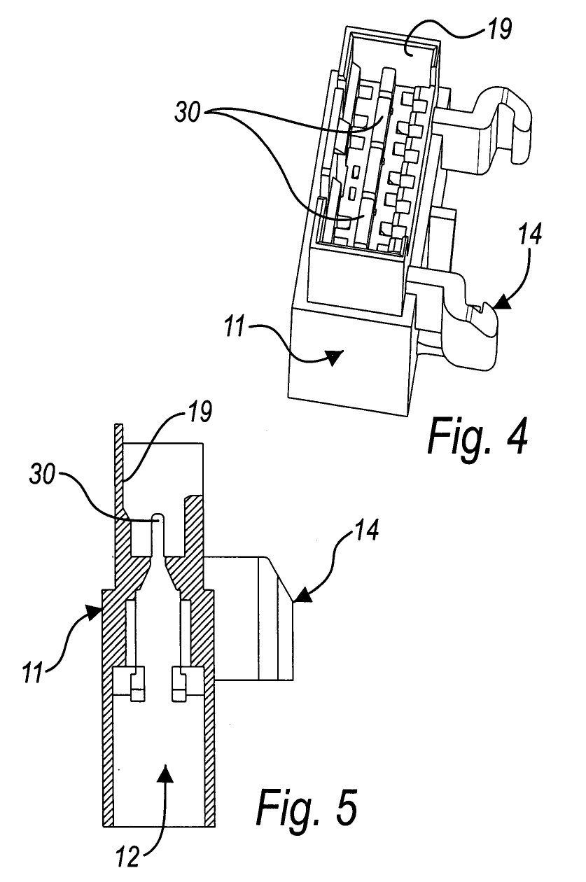

Each first internal passage 12 has a narrower portion 24 (FIG. 2) which divides said passage into a first part 25, which is occupied by the crimping portion 22, and a second part 26, which is occupied by the central flat body 20; the narrower portion 24 forms, on the second part 26, shoulders 27 against which the ends of the teeth 23 abut.

The narrower portion 24 is smaller than the distance between the vertex of the teeth 23 and the central flat body 20.

The passage of the central flat body 20 is allowed by the fact that the two teeth 23 are elastically deformable.

The central flat body 20 of each first electrical terminal 13 has, on the side walls that correspond to the lateral portions on which the teeth 23 are provided, two mutually opposite stroke limiting abutments 28 for insertion in the corresponding first internal passage 12.

The second electrical terminals 18 have a portion for connecting to the first male terminals 13, which consists of a pair of mutually opposite wings 29 (shown schematically in broken lines in FIG. 1; only one is visible in FIG. 2), which clamp the end 21 of the first electrical terminals 13 and are connected to the power supply of the motor.

In order to prevent the flat pins 21 of the first electrical terminals 13 from oscillating excessively within the cavity 19, with the risk of bending during the mating of the second connector 16 to the first connector 11, lateral guiding shoulders 30 for the flat pins 21 protrude from the bottom of the cavity 19.

The lateral guiding shoulders 30 guide two first mutually opposite side walls 21a of the flat pins 21, while the second mutually opposite side walls 21b are free in order to allow electrical contact with the second electrical terminals 18.

In particular, the width of the lateral guiding shoulders 30 is narrower than the distance between the second mutually opposite side walls 21b , thus allowing the pins to protrude from the shoulders 30 and ensure electrical contact with the second electrical terminals 18.

It should be noted that said shoulders provide a discontinuous cross-member on the bottom of the cavity 19.

In practice it has been found that the invention thus described achieves the intended aim and objects.

The structure of the connecting assembly according to the invention in fact allows a wiring which is particularly stable and easy to assemble.

This is possible by virtue of the fact that a first electrical terminal is used which has two extraction-preventing teeth arranged in a parallel configuration on lateral portions of said terminal, which allow an extremely stable arrangement thereof during assembly and during operation.

The arrangement of the teeth on lateral portions of the terminal allows to provide, within the cavity for mating of the second connector to the first connector, guiding shoulders for the flat pins.

The invention thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. PD2006A000394 from which this application claims priority are incorporated herein by reference.

What is claimed is:

1. An assembly for connecting stator windings of an electric motor having a stator to a respective power supply, comprising: a first box shaped connector provided with first internal passages which are open at an end part thereof and accommodate corresponding first electrical terminals; connection means for coupling said first connector to the stator, said connection means being adapted to arrange said first internal passages parallel to an axis of the electric motor; a coupling cavity, provided at the end part of said first internal passages, for coupling of at least one second box shaped connector, said second connector being provided with second internal passages which are open at an end part thereof and accommodate corresponding second electrical terminals for coupling to said first electrical terminals, said second internal passages being aligned with said first internal passages; and wherein each of said first electrical terminals is constituted by a central flat body which has a substantially quadrangular shape and has on a first side thereof a flat pin that protrudes therefrom coplanar for contact with a respective said second electrical terminal and, on a second opposite side with respect to said first side, a crimping portion for crimping to a corresponding cable connected to the stator windings; two teeth protruding from a surface of said central flat body and being adapted to avoid extraction of said first electrical terminals from the first internal passages, said two teeth being formed on said flat body along lateral contour portions of said quadrangular shape which are parallel to said flat pin; lateral guiding shoulders for said flat pins protruding from a bottom of said coupling cavity, said lateral guiding shoulders being suitable to guide two first mutually opposite side walls of said flat pins, with second mutually opposite side walls of said flat pins remaining free in order to allow electrical contact with said second electrical terminals.

2. The assembly of claim 1, wherein said two teeth are constituted by portions of said central flat body which are wing-shaped, are partially blanking cut and are folded so as to rise from a flat extension of said central flat body.

3. The assembly of claim 2, wherein said two teeth are mutually identical and parallel.

4. The assembly of claim 1, wherein each of said first internal passages has a narrower portion which divides each said first internal passage into a first part, which is occupied by said crimping portion, and a second part, which is occupied by said central flat body, said narrower portion forming on said second part shoulders against which ends of said teeth abut, said narrower portion having smaller dimensions than a distance between a vertex of said teeth and said central flat body.

5. The assembly of claim 4, wherein said central flat body of a said first electrical terminal has, on lateral sides thereof, two mutually opposite stroke limiting abutments for insertion in a corresponding one of said first internal passages.

6. The assembly of claim 4, wherein said second electrical terminals have a portion for connecting to said first electrical terminals which consists of a pair of mutually opposite wings, said wings clamping said flat pin of said first electrical terminals and being connected to a power supply of the motor.

7. The assembly of claim 1, wherein said lateral guiding shoulders have a width that is narrower than a distance between said second mutually opposite side walls, whereby to allow said pin to protrude from said shoulders and ensure electrical contact with said second electrical terminals.
